(19) United States
(12) Patent Application Publication
(10) Pub. No.: US 2006/0136729 A1
(43) Pub. Date: Jun. 22, 2006

(54) Copy protection for optical discs

(75) Inventor: William Henry Christopher Doyle, Berkshire (GB)

Correspondence Address: PATENT DEPARTMENT;MACROVISION CORPORATION, 2830 DE LA CRUZ BLVD., SANTA CLARA, CA, 95050, US

(73) Assignee: Macrovision Europe Limited

(21) Appl. No.: 11/018,105

(22) Filed: Dec. 20, 2004

(51) Int. Cl. H04L 9/00

(52) U.S. Cl. 713/176

(57) ABSTRACT

Optical discs, such as CDs, have been protected by the use of an authenticating signature which cannot be copied to another disc. A playing device is required to identify the existence of the authenticating signature in order to access the content of the disc. The authenticating signature may comprise bad sectors at known locations. CD writers now available to consumers allow error detection and error correction data to be specified and this has led to circumvention techniques designed to simulate an original disc. During the writing of a copy disc, bad sectors are identified and provided with alternative data together with incorrect error detection and error correction data. When the copy disc is played bad sectors are reported in exactly the same locations as reported by the original disc thereby enabling the disc to be played even though it is a copy. To defeat techniques which use the error detection and error correction data to circumvent the copy protection, it is proposed to store authenticating signatures in sectors in Mode 2 format. Sectors formatted in this way are not subject to error detection and correction.

### BACKGROUND TO THE INVENTION

The present invention relates to a copy protected optical disc carrying an authentication signature, to a method of copy protecting optical discs, and to a content file for use in manufacturing a copy protected optical disc.

Optical discs, such as the various formats of compact discs (CDs), and of digital versatile discs (DVDs), are increasingly used for carrying information for many different applications. The information encoded onto the optical discs is generally very valuable, and accordingly, they are increasingly copied by counterfeiters. Furthermore, recordable CDs are available, and CD writers for writing the information content from one disc to such recordable discs are readily available to the domestic consumer. This means that new and effective methods for copy protecting the optical discs are required.

There is described, for example, in WO 98/57413, a method of providing an optical disc with an authenticating signature. This authenticating signature is arranged so that it is not, or cannot be, copied by available devices for reading and writing data from CDs. For example, in WO 98/57413, a sector of a CD is provided with a pattern of errors which cannot be corrected by the error correcting rules and thereby constitutes an uncorrectable sector or “bad sector” on the disc. The existence of the expected bad sector is taken as an authenticating signature and is used to identify a genuine disc.

WO 02/11136 also describes the use of an authenticating signature but, in this case, the inherent limitations of currently available CD writers are exploited. Thus, in WO 02/11136 it is proposed that during mastering an authenticating signature is written to the glass master. This authenticating signature is made up of data patterns which cannot be accurately written by a writer for recordable discs so that when attempts are made to copy an original disc made from the glass master, the consumer's CD writer will find it difficult or impossible to write the authenticating signature to the copy disc with good readability. However, the much more sophisticated encoders used in mastering houses, for example, can be controlled to accurately write such an authenticating signature to the glass master.

In WO 02/11136, the data patterns of the authenticating signature are preferably chosen to cause digital sum value (DSV) problems for CD writers.

The two signature methods described above, in common with other signature methods, require that a correct signature is readable from the disc before the disc can be successfully operated. In addition, the existence of corrupted or otherwise incorrect data in the sector where the signature should have been can be used to signify that the disc is not original whereby its use may be prevented.

Originally devices for writing CDs generated the bit sequence to be written to disc, including error correction and error detection codes, automatically in dependence upon built in software including formatting rules. However, new generations of consumer CD writers allow error detection and correction codes to be specified by the user when copying an original disc. A number of circumvention devices make use of this facility to circumvent signature protection techniques so that a copied disc looks, to copy protection software, to be an original disc.

Thus, during play of a disc with an authenticating signature as set out, for example, in WO 98/57413, the playing device is controlled, at the outset, to find a bad sector in an expected location before it is enabled to access the content of the disc. By using a CD writer which allows a choice of error correcting and error detecting codes, it is possible to put any data into the sector which carried the authenticating signature on the original disc and then to change the error correcting and error detecting codes such that, upon play of the resultant copy disc, a bad sector is reported. The identification of a bad sector in the same location is taken by the copy protection software to signify a genuine disc.

Manipulation of the error correction and error detection codes similarly allows a disc copied from an original protected with an authenticating signal as described in WO 02/11136 to simulate an original disc.

### SUMMARY OF THE INVENTION

The present invention seeks to defeat circumvention techniques which involve altering error correcting and error detecting codes.

According to a first aspect of the present invention there is provided a copy protected optical disc carrying an authentication signature, the authentication signature being arranged so that it cannot be accurately copied by a writer of recordable discs, and wherein the authenticating signature is located on the optical disc in a manner which identifies that there is no error detection nor error correction data associated therewith.

For example, where the optical disc carries data in sectors, the authenticating signature may be provided in at least one sector on the optical disc which is in Mode 2 format.

Mode 2 format is a format for sectors on an optical disc which do not include error detection nor error correction data. Accordingly, when a playback device sees a sector which is in the Mode 2 format it does not subject the data in the sector to the error detection and error correction routines. Similarly, circumvention devices making use of the error detection and error correction data to simulate an original disc will be prevented from simulating the authenticating signature by the format of the sector.

In a further embodiment of the invention, where the authenticating signature is provided in a Mode 2 format sector, the authenticating signature can additionally be accompanied in the or each sector by appropriate error detection and error correction data.

In this embodiment, the circumvention device still sees that this data is in Mode 2 format and is thereby unable to access the error detection and error correction data. However, it can be arranged for a playback device to use the error detection and error correction data to obtain a corrected authenticating signature.

The nature of the authenticating signature used in embodiments of the invention may be chosen as required.

In one embodiment, where the optical disc carries a sequence of bits representing data stored on the disc, and the sequence of bits is arranged in sectors, the authenticating signature may have been produced by altering selected bits in at least one sector to provide a pattern of erroneous bits which cannot be corrected during playback.

Preferably, the sequence of bits comprises bits representing content and error correction and error detection data, and the bits which have been altered are bits representing content.

Additionally and/or alternatively, the authenticating signature is made up of data patterns chosen to cause DSV problems for writers of recordable discs.

For example, the data patterns may be chosen to ensure that the DSV has a significant absolute value. Additionally and/or alternatively, the data patterns which are chosen to cause DSV problems may be arranged to have a DSV which has a rapid rate of change.

The present invention also extends to a copy protected optical disc carrying a sequence of bits representing the data stored on the disc, the sequence of bits being arranged in sectors, the optical disc having an authentication signature in at least one sector, the authentication signature having been produced by altering selected bits to provide a pattern of erroneous bits which cannot be corrected during playback, and wherein the authenticating signature is located on the optical disc in a manner which identifies that there is no error detection nor error correction data associated therewith.

According to a further aspect of the present invention there is provided a copy protected optical disc carrying data arranged in sectors and having an authenticating signature in at least one sector, wherein the authenticating signature is made up of data patterns chosen to cause DSV problems for writers of recordable discs, and wherein the authenticating signature is located on the optical disc in a manner which identifies that there is no error detection nor error correction data associated therewith.

The present invention also extends to a method of copy protecting optical discs, the method comprising adding an authenticating signature to an optical disc during its mastering process, the authenticating signature being arranged so that it cannot be accurately copied by a writer for recordable discs, and the method further comprising locating the authenticating signature on the optical disc in a manner which identifies that there is no error detection nor error correction data associated therewith.

In an embodiment, the method further comprises arranging data carried by the optical disc in sectors, and providing the authenticating signature in at least one sector on the optical disc which is in Mode 2 format.

Additionally and/or alternatively, the method further comprises accompanying the authenticating signature in the or each sector with appropriate error detection and error correction data.

A method of an embodiment of the invention further comprises representing data on the optical disc by a sequence of bits encoded onto the disc, and arranging the bits of the sequence in sectors, and producing the authenticating signature by altering selected bits to provide a pattern of erroneous bits which cannot be corrected during playback.

Additionally and/or alternatively, the method comprises making up the authenticating signature from data patterns chosen to cause DSV problems for writers of recordable discs, arranging data carried by the disc in sectors, and locating the authenticating signature in at least one sector.

According to a still further aspect of the present invention there is provided a content file for use in manufacturing a copy protected optical disc carrying an authentication signature, the authentication signature being arranged so that it cannot be accurately copied by a writer of recordable discs, the content file comprising data to be stored on the optical disc, the data being arranged in sectors and being provided with appropriate error detection and error correction data, and the data including the authentication signature which is arranged in at least one sector, the or each sector containing the authentication signature being formatted in a manner which identifies that there is no error detection nor error correction data associated with the authenticating signature.

Preferably the content file is arranged to be used by an encoder during mastering of an optical disc.

Preferably, the or each sector in which the authenticating signature is arranged is in Mode 2 format.

Additionally and/or alternatively, the or each sector containing the authenticating signature also contains appropriate error detection and error correction data.

In an embodiment, the data is to be encoded to form a sequence of bits to be stored on the optical disc, and the content file includes means for altering selected bits of the sequence of bits during encoding to provide a pattern of erroneous bits defining the authenticating signature.

Additionally and/or alternatively, the authenticating signature is made up of data patterns chosen to cause DSV problems for writers of recordable discs.

In an embodiment, the data patterns are chosen to ensure that the DSV has a significant absolute value.

Additionally and/or alternatively, the data patterns which are chosen to cause DSV problems are arranged to have a DSV which has a rapid rate of change.

### BRIEF DESCRIPTION OF THE DRAWINGS

Embodiments of the present invention will hereinafter be described, by way of example, with reference to the accompanying drawings, in which:

FIG. 1 shows the surface of a compact disc, very much enlarged, showing the pits thereon,

FIG. 2 shows a cross-section of a pit illustrating the data associated therewith,

FIG. 3 shows schematically a process for encoding data onto a CD,

FIG. 4 shows schematically a mastering process for a CD in which an authenticating signature is added to the disc,

FIG. 5 shows a logical map of the recording area of a CD having an authenticating signature,

FIG. 6 shows the DSV associated with the pits and lands illustrated,

FIG. 7 illustrates a Mode 1 sector format,

FIG. 8 illustrates a Mode 2 sector format,

FIG. 9 illustrates a first example of an embodiment of the present invention,

FIG. 10 illustrates a further example of an embodiment of the present invention,

FIG. 11 shows a further implementation of an embodiment of the present invention, and

FIG. 12 shows a fourth implementation of an embodiment of the present invention.

### DESCRIPTION OF PREFERRED EMBODIMENTS

In the description which follows, the invention is described specifically by reference to the encoding of a CD-ROM and hence with reference to the use of the present invention for copy protecting such a CD-ROM. However, it will be appreciated that the present invention is not limited to use with a CD-ROM and finds application to all data carrying optical discs. Specifically, the invention is applicable to all formats of CDs and to all formats of DVDs.

Furthermore, the description which follows gives one example of the encoding of data onto a CD. Other encoding modes are possible and it will be appreciated that the invention is not limited to the encoding mode.

It will be appreciated that the data to be encoded onto a CD is formatted according to well known standards such that an extensive description of the formatting and encoding is not required and is not provided.

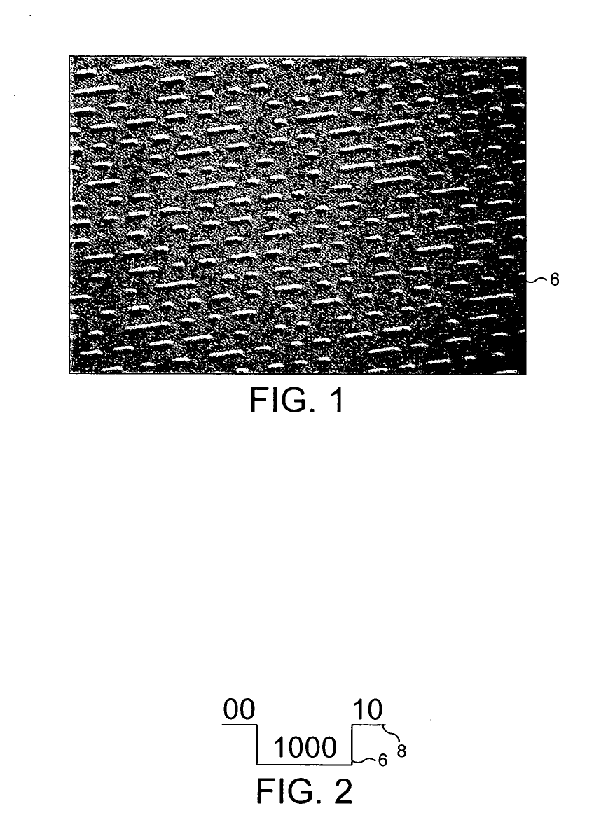

FIG. 1 shows an enlarged view of part of a CD showing the pits 6 thereon. As is well known, these pits extend along a spiral track on the surface of the disc and are separated by lands.

FIG. 2 shows a section through a pit 6 and land 8 illustrating how data is encoded on a CD. The pits and lands do not represent binary 0s and 1s, but instead represent transitions from one state to another. The data signal is stored in NRZI form (Non-Return to Zero Inverted), where the signal is inverted every time a 1 is encountered. FIG. 2 shows the binary value 00100010.

The data stream always consists of pits and lands of at least 3 bits and at most 11 bits long. This is sometimes referred to as a 3T-11 T where T is a 1 bit period. A 3T pit has the highest signal frequency (720 khz) and an 11T pit has the lowest signal frequency (196 khz). A data signal is derived from the lengths of the pits and lands. The data signal derived forms a square wave known as an EFM signal.

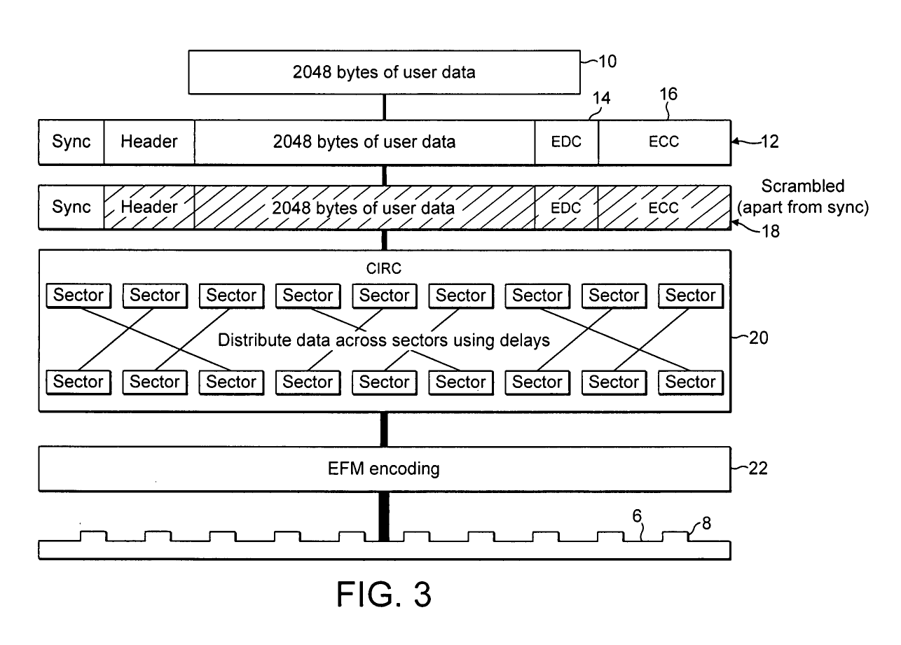

FIG. 3 shows schematically the encoding of data onto a CD in the form of pits 6 and lands 8. The data is arranged in sectors and initially, and as indicated, there are 2048 bytes of user data in a sector. This is indicated at 10. Then, as illustrated at 12, a sync block, a header, error detection code (EDC) 14 and error correction code (ECC) 16 are added to those original 2048 bytes.

The data at 12 is then scrambled as shown at 18. The scrambling effectively randomizes the data across a sector to reduce the likelihood of repeating patterns of user data which can cause problems.

As indicated at 20, the data is then passed to the CIRC (Cross Interleaved Reed-Solomon Code) encoder. The CIRC encoder, by means of delays, distributes the data across a number of sectors, which also reduces the likelihood of repeating patterns of user data. The data is then passed to the EFM encoder 22 where it is converted into the pattern of 1's and 0's, that is, a sequence of bits. It is the EFM encoded data, which also incorporates merge bits, which is converted into the series of pits and lands, on the disc.

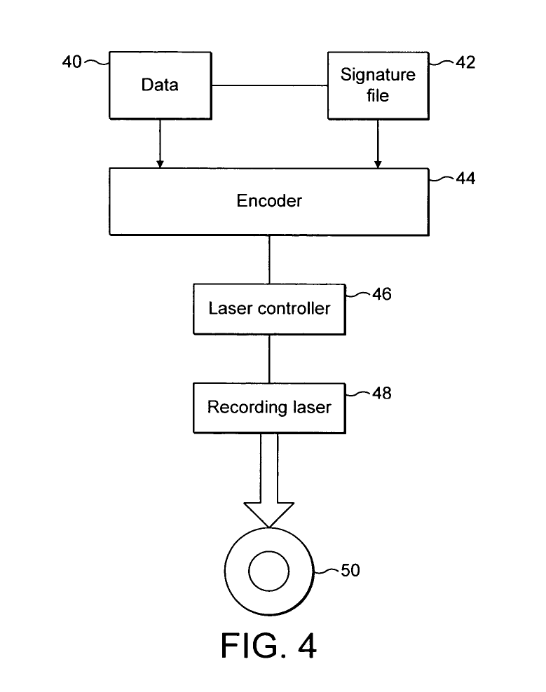

FIG. 4 illustrates schematically a mastering process for a CD in which an authenticating signature is added to the disc. In this respect, during the mastering process, data 40 for the glass master and data 42 for the authenticating signature are provided to an encoder 44 associated with a laser beam controller 46. The controller 46 operates the recording laser 48 to write the data to a glass master 50. Original CDs may then be replicated from the glass master in conventional manner.

The data 40 and the data 42, together with appropriate instructions, define a content file for use in the encoding process illustrated in FIG. 4. This content file may be provided, for example, on a single CD-R or may be split across two or more CD-Rs.

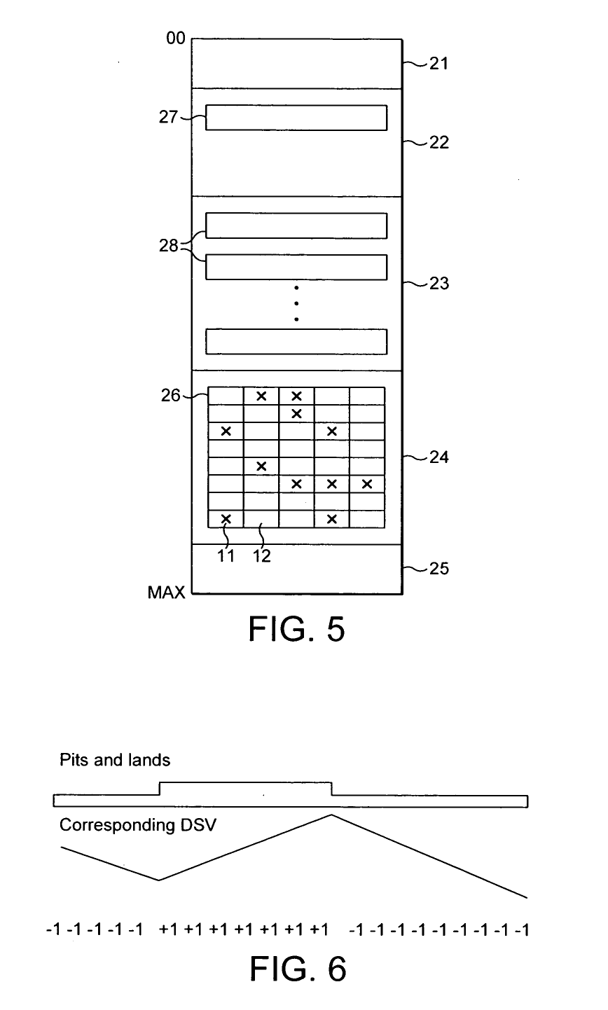

FIG. 5 illustrates a logical map of the data area of a CD having an authenticating signature as described in WO 98/57413. The data area is sub-divided into addressable sectors from the top at address 00 to the final address MAX. The first area 21 is a Lead-In or pre-gap area. The second area is a system area 22 containing, for a CD-ROM, the primary volume descriptor 27. The remaining part of the data area is available for user data which may, for example, be arranged in user files 28.

In the arrangement shown in FIG. 5, a fourth area 24 comprises a padding area 26 made up of error sectors 11 indicated by X and non-error sectors 12. The error sectors 11 together provide the authenticating signature.

Each of the error sectors 11 contains errors made by altering bits in the bit sequence in the particular sector 11. The number of bit errors is such that they are uncorrectable by error correcting rules. In addition, the originally generated error detection and error correction codes are kept so that the data in the error sector 11 is inconsistent with the error detection and error correction codes. Thus, in applying the authenticating signature to the disc, the user data is processed as shown in FIG. 3 until the EFM encoding stage. At EFM encoding the signature file causes the alteration of the generated bits to be encoded on to the disc.

When a disc is to be read, it is subject to decoding by a process which is substantially the reverse of that shown in FIG. 3. Thus, the decoded sequence of bits is subject to de-interleaving and de-scrambling and then the error detection codes and error correction codes are used by error detection and error correction routines to correct the user data thereby obtained.

However, the signature method shown in FIG. 5 ensures that the error sectors 11 are identified as bad sectors by the playing or reading device.

Generally, the copy protected compact disc will include copy protection software requiring the existence of the error sectors at the known locations to be identified before the playback device is enabled to access to the content of the disc.

Previously, a CD having copy protection by way of an authenticating signature as illustrated in FIG. 5 prevented writers available to consumers from making usable copies of the disc. Thus, the writer on reading the user data would discard the error correction and error detection codes. The writer would then write the user data obtained to the copy disc by generating a new bit sequence encoding the user data and including newly generated and inherently correct error correction and error detection bits. Therefore, the pattern of logical errors would be lost and no authenticating signature would appear on the copied disc.

However, the new generation of writers for recordable discs which are now available enable the user to specify the error detection and error correction codes to be used when recording data on to a recordable disc. These new writers can be used legitimately, for example, to enable the user to re-record damaged discs. As the error detection and error correction data could be damaged, as well as the user data on the disc, the new generation of writers provide the facility that error detection and error correction data can be chosen during recording. One choice which can be made is to copy the existing error detection and error correction data.

A number of circumvention techniques now make use of this facility to choose the specific error detection and error correction data to make copies of copy protected discs which can trick copy protection software into identifying a copy disc as an original disc.

Thus, the authenticating signature technique generally provides a corrupt sector with error detecting and error correcting codes which are inconsistent with the sector data. When an attempt is made to retrieve the authenticating signature, a bad sector is flagged. The circumvention technique identifies each such bad sector. The copying software is then used to write data to that sector and then to provide error detection and error correction codes which are inconsistent with the written data so that a bad sector is reported. In this respect, to ensure that the error detection and error correction codes are inconsistent with the data written to the sector, the error detection and error correction codes might be copied from the original disc.

When, therefore, the copy disc made by this circumvention technique is played, errors are reported in the same location as on the original disc. That is, the copy protection software identifies bad sectors in the same locations as on the original disc and therefore identifies the existence of the authentication signature signalling that the disc is authentic. Access to the content of the disc is thereby enabled.

In WO 02/11136 there is described a method of providing an authenticating signature which, instead of using errors on the disc, encodes the user data using data patterns which are capable of causing DSV problems. In this respect, the digital sum value (DSV) is the running difference between the number of T values where the EFM represents a pit and the number of T values where the EFM represents a land. As each data bit is read, the DSV is incremented or decremented depending upon whether the data bit corresponds to a pit or a land.

As is indicated in FIG. 6, the DSV is determined by assigning the value +1 to each land T, and −1 to each pit T. Ideally, the DSV should stray as little as possible from the zero level. If the DSV has a rapid rate of change over a significant period of time, or if the DSV has substantial low frequency components, then the transitions in the EFM signal may be shifted from their ideal values and/or the ability of tracking and focus circuits in CD drives to maintain optimal head positioning may be compromised. This typically causes read failures from the CD.

Original data, in 8 bit bytes, is passed through EFM encoding to produce 14 bit symbols. The set of 14 bit symbols is especially designed:

to level out the number of pits and lands, to help maintain balanced DSV; and

to ensure that there are no symbols which break the EFM coding scheme of 3T-11T.

However, it is still possible to have two 14 bit symbols, which when joined together would compromise the coding scheme. Accordingly, a set of 3 merge bits are added between each 14 bit symbol to ensure that there are no violations of the 3T-11T coding scheme and to ensure that a suitable DSV is maintained.

In order to maintain good DSV characteristics, the encoder often has a choice in the merge bits to insert between the symbols which carry the data. A sophisticated encoder, such as those which control laser beam recorders, may have the foresight, or can be designed, to choose a pattern of merge bits which is not optimal for the immediate locality where this area is followed by one in which the run length limiting rules dictate the merge bits. The result will be that the overall DSV for the two areas will have better properties. The ability to detect upcoming areas where the merge bit choices are limited is called “look-ahead”. Encoders with a larger look-ahead will be able to make more preparations for encoding the troublesome data and hence the overall encoding will be better. CD writers typically have very little ability to look ahead and hence when they lose control of the DSV, it is more likely to result in an unreadable disc.

The applicants identified a number of values which are capable of causing DSV problems because of their EFM pattern at the pits and lands level. When the patterns for these values are processed through the EFM decoder of a CD drive, the DSV accumulates or decrements and this can result in read failures. Of course, and as indicated above, the encoding process for a CD is designed to prevent values capable of causing DSV problems occurring in the EFM pattern as well as providing robust error correction.

To provide an authenticating signature for a CD, data patterns are chosen which are known to cause DSV problems. For example, and as described above, the data patterns may include sectors filled with repeated values. The glass master is created to have the authenticating signature on it by overcoming the effects of the XOR scrambling and the CIRC encoding.

To overcome the effects of scrambling, the data patterns intended to provide an authenticating signature are XOR'd with the same pattern of scrambling data as is used in the scrambling process indicated at 18 in FIG. 3. This scrambled data is then subjected to rest of the process indicated in FIG. 3. It will be appreciated that when the scrambled data is subjected to the XOR algorithm on encoding, each byte from the sector will be returned to its original value.

The mixing effect of the CIRC encoder, which is indicated at 20, can be partially overcome by writing multiple copies of the sector. For example, sectors N+1, N+2, N+3 and N+4 will contain the same user data as sector N.

The writers for recordable discs which enable a choice of error detection and error correction data on recording, can also be used to circumvent an authentication signature using DSV data patterns as described above. In this respect, it is necessary during the circumvention technique to identify the sectors on the original disc which include the data patterns known to cause DSV problems. Then the data patterns in those sectors are changed to ones which do not cause DSV problems. However, the original error detection and error correction codes of those sectors are kept. The copy disc can then be written without problem, and when this copy disc is read the original data will be output because of the presence of the original error detection and error correction codes.

The present invention provides techniques for defeating the further circumvention techniques described above.

It will be seen in FIG. 3, for example, that the sectors 12 containing the user data are provided with error detection and error correction codes 14 and 16. This is an extra level of error correction, over and above that associated with the de-interleaving and de-scrambling routines. This further error correction is required when the data on a disc is computer data, programs, text and the like, where accurate decoding is essential.

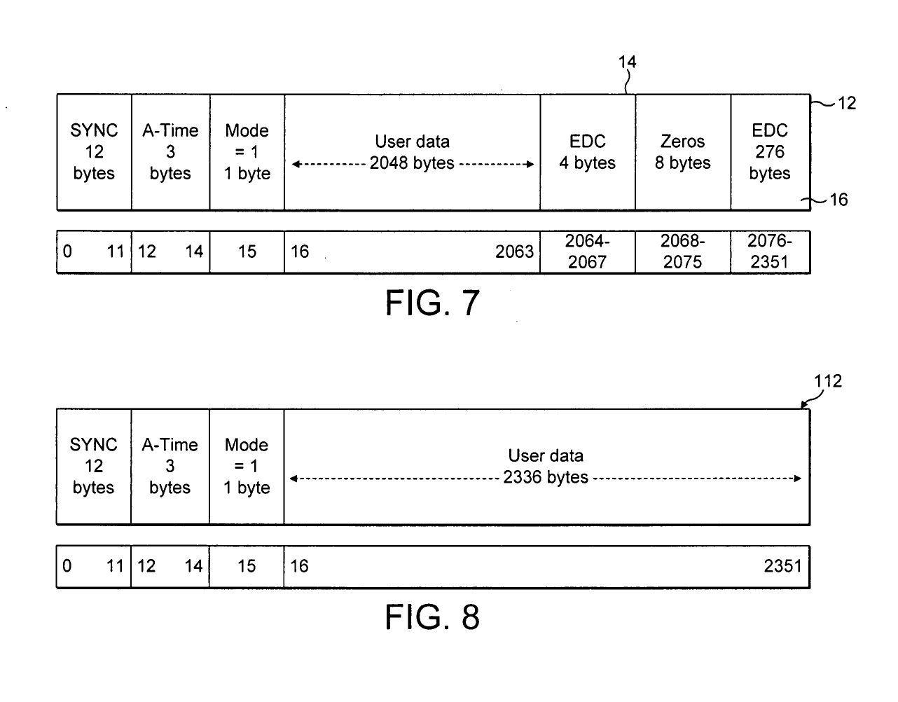

The sector 12 illustrated in FIG. 3 is a Mode 1 sector. The elements of a Mode 1 sector are shown in more detail in FIG. 7. As can be seen in FIG. 7, the sector 12 comprises 12 sync bytes. The header is divided into 3 A-time bytes and a single byte identifying the Mode. In this case the Mode is 1. The 2048 bytes of user data are then followed by error detecting data 14 and error correcting data 16.

It will be appreciated that when decoding the data on a CD the C1 and C2 decoders which perform the de-interleaving and de-scrambling provide two levels of error correction. The error detecting and error correcting data in Mode 1 therefore provides a third level of error correction.

As set out above, the Mode 1 format sector is mandatory for computer data. However, it is not needed for data such as audio and video where interpolation can be used instead of error correction. Accordingly, it is possible to format audio and video user data in Mode 2 sectors as illustrated in FIG. 8.

In FIG. 8, the sector 112 has the sync data and the header divided into A-time and mode as in the Mode 1 format. However, the Mode is set as 2. Thereafter, the sector is filled with 2336 bytes of user data.

To prevent the circumvention techniques as described above from using the error detection and error correction data to simulate original discs, it is proposed that an authenticating signature, as described, should be incorporated in one or more sectors formatted as Mode 2 sectors.

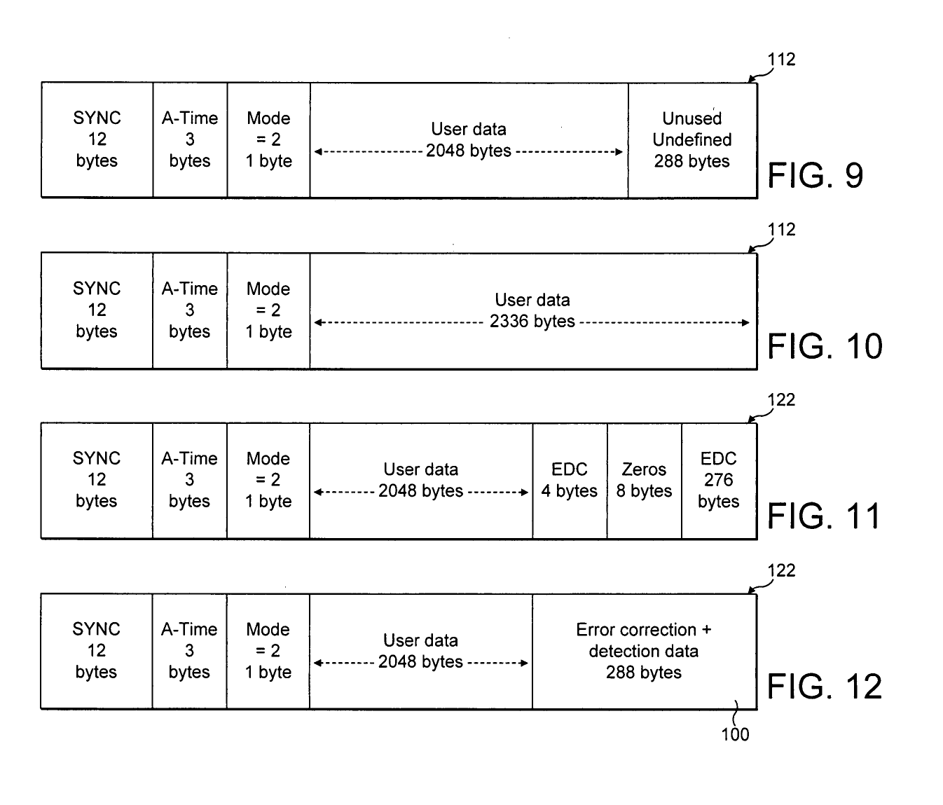

A first example of the invention is shown in FIG. 9 in which an authenticating signature, or part thereof, is stored in a Mode 2 format sector 112. This authenticating signature might be identical to that used previously and thus will comprise only 2048 bytes of user data. The sector 112 therefore has 288 bytes of undefined data.

The circumvention techniques described above are not able to alter the data within the sector 112 as described above because of the omission of the error detection and error correction data. A copy of the sector can still be made but the copy protection will then work as designed. Thus, if the authenticating signature includes data patterns chosen to cause DSV problems, the resultant copy disc will have DSV problems and is likely to be unreadable. If the authenticating signature is a corrupt sector, the C1 and C2 error correction should still flag the existence of the bad sector such that the data therein will not be written to the copy disc in a format identifiable as an authenticating signature.

FIG. 10 shows a similar embodiment to that of FIG. 9 except that all of the area in sector 112 available for user data has been made available for the authenticating signature or part thereof. This means that the authenticating signature can be made larger, and therefore more effective.

In the embodiment as shown in FIG. 11 there is a sector 122 which appears to have the content of a Mode 1 format sector but is specified to be in Mode 2 format. The sector 122 might have been produced, for example, by copying a Mode 1 sector including an authenticating signature and writing it as a Mode 2 format. Thus, the user data in the sector 122 includes the authenticating signature which is followed by its original error detection and error correction codes. However, when trying to circumvent the copy protection on the disc as described, the copying device identifies the error detection and error correction data in sector 122 as user data. Additionally, the copy protection software can be arranged to access this data to perform error correction routines on the authenticating signature. The embodiment shown in FIG. 11, therefore, is more robust as it enables the player or reader of the original disc to obtain the authenticating signature even if there are defects on the original disc.

FIG. 12 shows a sector 122 having a similar format to that of FIG. 11 except that an extra user data area 100 is used to store specific error detection and error correction data to provide error correction for the authenticating signature. The type of error detection and error correction data may be specified as required and may be, for example, Hamming Code as defined in Federal Standard 1037C.

It will be appreciated that variations in and modifications to the invention as described and illustrated may be made within the scope of the appended claims.

1. A copy protected optical disc carrying an authentication signature, the authentication signature being arranged so that it cannot be accurately copied by a writer of recordable discs, and wherein the authenticating signature is located on the optical disc in such a manner which identifies that there is no error detection nor error correction data associated therewith.

2. A copy protected optical disc according to claim 1, carrying data in sectors, and wherein the authenticating signature is provided in at least one sector on the optical disc which is in Mode 2 format.

3. A copy protected optical disc according to claim 1, carrying data in sectors, wherein the authenticating signature is provided in at least one sector on the optical disc which is in Mode 2 format, and wherein the authenticating signature is accompanied in the or each sector by appropriate error detection and error correction data.

4. A copy protected optical disc according to claim 1, carrying a sequence of bits representing data stored on the disc, the sequence of bits being arranged in sectors, and wherein the authenticating signature has been produced by altering selected bits in at least one sector to provide a pattern of erroneous bits which cannot be corrected during playback.

5. A copy protected optical disc according to claim 4, wherein the sequence of bits comprises bits representing content and error correction and error detection data, and wherein the bits which have been altered are bits representing content.

6. A copy protected optical disc according to claim 1, wherein the authenticating signature is made up of data patterns chosen to cause DSV problems for writers of recordable discs.

7. A copy protected optical disc according to claim 6, wherein the data patterns are chosen to ensure that the DSV has a significant absolute value.

8. A copy protected optical disc according to claim 6, wherein the data patterns which are chosen to cause DSV problems are arranged to have a DSV which has a rapid rate of change.

9. A copy protected optical disc carrying a sequence of bits representing the data stored on the disc, the sequence of bits being arranged in sectors, the optical disc having an authentication signature in at least one sector, the authentication signature having been produced by altering selected bits to provide a pattern of erroneous bits which cannot be corrected during playback, and wherein the authenticating signature is located on the optical disc in a manner which identifies that there is no error detection nor error correction data associated therewith.

10. A copy protected optical disc according to claim 9, carrying data in sectors and wherein the authenticating signature is provided in at least one sector on the optical disc which is in Mode 2 format.

11. A copy protected optical disc according to claim 9, carrying data in sectors, and wherein the authenticating signature is provided in at least one sector on the optical disc which is in Mode 2 format, and wherein the authenticating signature is accompanied in the or each sector by appropriate error detection and error correction data.

12. A copy protected optical disc according to claim 9 or claim 10, wherein the sequence of bits comprises bits representing content and error correction and error detection data, and wherein the bits which have been altered are bits representing content.

13. A copy protected optical disc carrying data arranged in sectors and having an authenticating signature in at least one sector, wherein the authenticating signature is made up of data patterns chosen to cause DSV problems for writers of recordable discs, and wherein the authenticating signature is located on the optical disc in a manner which identifies that there is no error detection nor error correction data associated therewith.

14. A copy protected optical disc according to claim 13, carrying data in sectors and wherein the authenticating signature is provided in at least one sector on the optical disc which is in Mode 2 format.

15. A copy protected optical disc according to claim 13, carrying data in sectors, and wherein the authenticating signature is provided in at least one sector on the optical disc which is in Mode 2 format, and wherein the authenticating signature is accompanied in the or each sector by appropriate error detection and error correction data.

16. A copy protected optical disc according to claim 13 or claim 14, wherein the data patterns are chosen to ensure that the DSV has a significant absolute value.

17. A copy protected optical disc according to claim 13 or claim 14, wherein the data patterns which are chosen to cause DSV problems are arranged to have a DSV which has a rapid rate of change.

18. A method of copy protecting optical discs, the method comprising adding an authenticating signature to an optical disc during its mastering process, the authenticating signature being arranged so that it cannot be accurately copied by a writer for recordable discs, and the method further comprising locating the authenticating signature on the optical disc in a manner which identifies that there is no error detection nor error correction data associated therewith.

19. A method of copy protecting optical discs according to claim 18, further comprising arranging data carried by the optical disc in sectors, and providing the authenticating signature in at least one sector on the optical disc which is in Mode 2 format.

20. A method of copy protecting optical discs according to claim 19, further comprising accompanying the authenticating signature in the or each sector with appropriate error detection and error correction data.

21. A method of copy protecting optical discs according to claim 18 or claim 19, the method comprising representing data on the optical disc by a sequence of bits encoded onto the disc, and arranging the bits of the sequence in sectors, and producing the authenticating signature by altering selected bits to provide a pattern of erroneous bits which cannot be corrected during playback.

22. A method of copy protecting optical discs according to claim 18 or claim 19, the method comprising making up the authenticating signature from data patterns chosen to cause DSV problems for writers of recordable discs, arranging data carried by the disc in sectors, and locating the authenticating signature in at least one sector.

23. A content file for use in manufacturing a copy protected optical disc carrying an authentication signature, the authentication signature being arranged so that it cannot be accurately copied by a writer of recordable discs, the content file comprising data to be stored on the optical disc, the data being arranged in sectors and being provided with appropriate error detection and error correction data, and the data including the authentication signature which is arranged in at least one sector, the or each sector containing the authentication signature being formatted in a manner which identifies that there is no error detection nor error correction data associated with the authenticating signature.

24. A content file for use in manufacturing a copy protected optical disc carrying an authentication signature according to claim 23, wherein the or each sector in which the authenticating signature is arranged is in Mode 2 format.

25. A content file for use in manufacturing a copy protected optical disc carrying an authentication signature according to claim 24, wherein the or each sector containing the authenticating signature also contains appropriate error detection and error correction data.

26. A content file for use in manufacturing a copy protected optical disc carrying an authentication signature according to claim 23, wherein the data is to be encoded to form a sequence of bits to be stored on the optical disc, and wherein the content file includes means for altering selected bits of the sequence of bits during encoding to provide a pattern of erroneous bits defining the authenticating signature.

27. A content file for use in manufacturing a copy protected optical disc carrying an authentication signature according to claim 23, wherein the authenticating signature is made up of data patterns chosen to cause DSV problems for writers of recordable discs.

28. A content file for use in manufacturing a copy protected optical disc carrying an authentication signature according to claim 27, wherein the data patterns are chosen to ensure that the DSV has a significant absolute value.

29. A content file for use in manufacturing a copy protected optical disc carrying an authentication signature according to claim 27, wherein the data patterns which are chosen to cause DSV problems are arranged to have a DSV which has a rapid rate of change.
